(19) United States
(12) Patent Application Publication
(10) Pub. No.: US 2010/0034979 A1
(43) Pub. Date: Feb. 11, 2010

(54) THERMAL SPRAYING METHOD AND DEVICE

(75) Inventor: Georgy Barykin, San Sebastian (guipuzcoa) (ES)

Correspondence Address: CANTOR COLBURN, LLP, 20 Church Street, 22nd Floor, Hartford, CT, 06103, US

(73) Assignee: FUNDACION INASMET, San Sebastian (guipuzcoa) (ES)

(21) Appl. No.: 12/305,504

(22) PCT Filed: Jun. 28, 2005
(86) PCT No.: PCT/ES06/00377

§ 371 Date: Oct. 7, 2009

(51) Int. Cl. C23C 4/12; B05B 7/20

(52) U.S. Cl. 427/446; 118/723 MP

(57) ABSTRACT

The thermal spraying method comprises the following steps:
introducing at least one fuel (C) and at least one combustion agent (D) into a combustion chamber (1), generating a combustion process and adding a coating material (F) to the flow of hot gas (E).

In addition, a partially ionized gas is generated and said partially ionized gas is introduced into the combustion chamber (1) to provoke the combustion of the fuel and combustive agent.

The invention also refers to a thermal spraying device.

### TECHNICAL FIELD OF THE INVENTION

The invention lies in the field of thermal spraying coating systems.

### BACKGROUND OF THE INVENTION

Thermal spraying procedures involve the generation of a gas flow which is used to accelerate particles of the coating material to be deposited and to direct them towards the surface or substrate to be coated, where they impact and on which they remain adhered. The interaction of the gas flow with the particles to be deposited (heat exchange, chemical reactions and transfer of mechanical moment), defines the features of the process and, ultimately, the nature and quality of the coatings generated.

A traditional classification, according to the technique used to generate said gas flow, could be the following:
Processes that make use of thermal plasmas, also known as plasma procedures.
Combustion processes.
Processes that use the expansion of gases at high pressures.

Plasma procedures are based on the use of two electrodes between which an electric current is established that generates an arc, through which a gas is passed so that it is ionized by the electric arc, producing as a result a stream of plasma which has a very high temperature (typically above 10,000° C.), its expansion being via an output nozzle which is used for the thermal spraying.

Due to their high temperature, plasma procedures permit the application of coatings with every kind of material, as they are capable of melting every type of powder or particle, both metallic and ceramic. These procedures, however, have the disadvantage that the output speed of the particles borne by the stream of plasma is not very high (it is usually in the region of 100-200 metres per second), so coatings can be obtained with a limited density, compactness or adherence. In addition, sometimes the temperature attained proves too high and the particles of the coating material undergo unwanted breakdown processes, so it may be necessary to include devices that lower the temperature of the stream of plasma. As examples of this type of technology, we may name the American patents U.S. Pat. No. 5,372,857, U.S. Pat. No. 5,019,686, U.S. Pat. No. 5,135,166, U.S. Pat. No. 5,330,798 and U.S. Pat. No. 6,003,788.

This means that plasma procedures are mainly used for spraying particles or powders requiring a very high temperature for their melting, as is the case of ceramic materials.

Combustion procedures are based on the combustion of gases in the interior of a spray gun, so that the combustion gases issue via the gun barrel at high speeds. The coating material is introduced into the gun so that, upon coming in contact with the gases at high temperature, it melts and issues from the barrel of the gun at high velocity, adhering to the piece to be coated.

These procedures are based on the creation of an environment of high-temperature (capable of melting the coating powders) and high pressure (in order to generate an output speed of the stream of gases that will achieve the adhesion of the melted powders on the piece or substrate).

Combustion procedures are basically divided into two main families, namely continuous high-velocity combustion procedures (HVOF=high velocity oxygen fuel and HVAF=high velocity air fuel, depending on whether they use oxygen or air, respectively), and pulsed combustion procedures, also known as detonation procedures.

As regards continuous high-velocity combustion procedures, they are based on the injection into the combustion chamber of a fuel and a combustion agent which, when ignited, produce a combustion reaction whose products issue via a hole in the combustion chamber in the form of a flow of hot gas entraining the coating particles.

Amongst the regularly used HVOF devices, we may distinguish between first and second generation devices. First generation devices generate a low pressure (3-5 bars) in the combustion chamber, so that the output velocity of the coating particles is not very high, which restricts the characteristics of the coating obtained. Second generation devices are based on the generation of a high pressure (5-10 bars) in the combustion chamber, in order to achieve a higher output velocity (400-700 metres per second) of the coating particles and, therefore, a higher density in the coatings obtained. This is achieved by injecting into the combustion chamber a large volume of gases (fuel+combustive agent) which naturally generates a higher pressure in the chamber. Additional inputs of air are sometimes used to increase the volume. Procedures of this type are described in American patents U.S. Pat. No. 5,372,857, U.S. Pat. No. 5,019,686, U.S. Pat. No. 5,135,166, U.S. Pat. No. 5,330,798 and U.S. Pat. No. 6,003,788.

One of the limitations of HVOF procedures is that the temperatures that may be reached depend on the type of fuel used, so that, depending on the material that has to be used for the coating, the fuel must also be used that will enable the combustion temperature needed for the fusion of the coating particles to be reached.

Thus, for instance, in an O₂ atmosphere:
Using hydrogen, temperatures of around 2100 degrees may be reached.
Using methane, 2200 degrees.
Using kerosene, 2700 degrees.
Using propylene, 2800 degrees.
Using acetylene, 3200 degrees.

Obviously, when we want to execute coatings with low melting-point metals, such as aluminium or copper for example, we may employ methane, for instance, which is easy to use and, furthermore, has a broad distribution network.

On the other hand, when we want to execute coatings with ceramic materials, we need high temperatures, which are only provided by propylene or acetylene. These are gases that require special equipment and make use of the procedures more complicated.

Furthermore, with the second generation HVOF devices, as mentioned above, to achieve a high spraying velocity, which is reflected in a superior coating quality, a high gas pressure is required in the combustion chamber (5-10 bars), which is achieved by injecting a large volume of gases into the combustion chamber. This entails two drawbacks: first of all, the high consumption of gases and, on the other hand, this high pressure is translated into a high power that brings about a stream of gases of considerable flow and length, which may lead to overheating of the substrate to be coated and even go so far as to damage it. As a result, substrate cooling systems are sometimes incorporated, which increase the complexity of the equipment and its cost.

HVOF procedures are not the most suitable for materials with a low melting point because the low temperature combustion processes that are required are much more stable and tend to be interrupted during the coating process. For materials of this type high-pressure gas expansion techniques are used which are described below.

Attempts have also been made to introduce improvements in HVOF procedures, aimed primarily at improving stability, efficiency and the range of fuel mixtures of utility in the combustion process. U.S. Pat. No. 5,932,293 describes how the combustion chamber is provided with a burner, which is a kind of disc that reaches high temperatures and helps to maintain the temperature, while facilitating the ignition of the combustion mixture. FIG. 6 of U.S. Pat. No. 5,932,293 is shown as a version in which a plasma torch is used in combination with the burner in order to extend the length of the flame generated by the plasma. This device in fact constitutes a plasma torch (the coating materials are melted by the actual plasma) with an enveloping gas, so the process which is implemented is no longer an HVOF process but a plasma process, with the limitations thereby entailed with regard, for example, to excessively high temperatures.

In pulsed combustion procedures or detonation processes, detonations take place cyclically to generate a stream of high-temperature gases, which flow out of the gun at very high velocity (flow) to produce the thermal spraying. As an example of processes of this type, we may mention American patents U.S. Pat. No. 2,714,563 and U.S. Pat. No. 6,517,010. These detonation processes are much more effective than continuous high-velocity combustion processes, as they successfully reduce the afore-mentioned gas consumption levels, costs and overheating.

Other thermal spraying procedures are those based on the expansion of gases at high pressures, also known as “cold spraying”, which consist of the use of a pressurised gas, without combustion, to entrain the coating powders. As an example of procedures of this type, we may mention U.S. Pat. No. 5,302,414. In this case, through using essentially kinetic energy, the particle spraying practically eliminates the unwanted effects of the thermal interaction of the materials to be sprayed with the gaseous medium. The coatings thus obtained present excellent characteristics in terms of density, compactness, adhesion and absence of oxidation or breakdown due to environmental reactivity. The use of these procedures, however, is limited to a few materials (mainly to metals with a low melting point and high plasticity) and for the volume of gases needed for the formation of the gaseous fluid, the costs prove prohibitive for many of the industrial applications.

Procedures of this type also require a system of heating (resistors, coils) for the pressurised gas in order to improve the characteristics of the process, so in practice, besides the purely kinetic component of the energy, there is always a thermal component in the energy intake experienced by the particles sprayed.

U.S. Pat. No. 6,986,471 describes an improvement in cold-spraying processes by means of the use of a plasma torch that provides a high-velocity gas flow with an additional energy input. In fact, it is a plasma spraying device equipped with an acceleration nozzle, in which gases are introduced at high pressure and enable the velocity of the spray jet to be increased. Therefore, in this device the mixture of plasmagenic gases takes place with cold gases under high pressure, thereby enabling the advantages of both spraying procedures to be combined and increasing the range and quality of the coatings obtained.

### DESCRIPTION OF THE INVENTION

It has been considered that it could be beneficial to develop processes capable of producing high-velocity (supersonic) gaseous flows with moderate temperatures, so that the thermal interaction between the materials to be deposited and the gaseous flow is low and, as a result, unwanted chemical reactions (typically oxidation or breakdown) are low too. Furthermore, a high velocity of the gaseous flow is synonymous of particles with high kinetic energy which develop, after the impact, coatings of high density and adhesion, as preferred in a large number of applications.

The system that is the object of this invention overcomes the limitations of the afore-mentioned equipment through being defined by a continuous high-velocity combustion process, in which the gases involved in said combustion include a flow of partially ionized gas generated by a low-power thermal plasma which acts as an initiator of the combustion process while also increasing the stability of said process. This also permits the generation of stable combustion processes for wider composition ranges (proportion of fuel+proportion of combustive agent) than those used in the traditional continuous combustion processes (HVOF).

A first aspect of the invention refers to a method of thermal spraying for executing coatings of pieces and/or substrates, which comprises the following steps:

introducing at least one fuel and at least one combustion agent into a combustion chamber with at least one outlet;

generating combustion of a mixture of said fuel and combustion agent in order to produce combustion gases in the combustion chamber, so that the combustion gases flow out of the aforesaid at least one outlet in the form of a hot gas flow (i.e. a flow of hot gas comprising combustion products);

adding a coating material (for example, in powder form) to said flow of hot gas downstream in relation to the combustion chamber, so that said coating material is mixed with the flow of hot gas; and

spraying the coating material, mixed with the flow of hot gas, onto at least one piece and/or substrate to be coated with the coating material.

In accordance with the invention, the method further comprises the following additional steps:

generating a partially ionized gas; and

introducing said partially ionized gas into the combustion chamber, so that it will bring about the combustion of said fuel and combustive agent.

The partially ionized gas is capable of maintaining the combustion process for wider composition ranges (proportion of fuel+proportion of combustive agent) than those used in the traditional continuous combustion processes (HVOF). In addition, the partially ionized gas not only acts initially to bring about combustion, but also introduction of the partially ionized gas into the combustion chamber is maintained throughout the whole thermal spraying process (i.e. during the combustion of said fuel and combustion agent in the combustion chamber).

For purposes of this invention, a partially ionized gas is considered to be one that, after being subjected to an electrical discharge, maintains a concentration of neutral particles higher than that of the charged particles (ions and electrons) generated by an electrical discharge.

As may be deduced, the procedure of the invention may be a second generation HVOF combustion procedure, i.e. with high pressures in the combustion chamber, but which incorporates for the activation of the combustion, a plasma or partially ionized gas at high temperature (for example, generated electrically). This activation may be produced continuously, i.e. it may be maintained throughout the whole time that the substrate is being sprayed. The partially ionized gas acts as a catalyst or initiator of combustion, modifying the mechanisms of reaction of the gases used in the combustion process. Therefore, the partially ionized gas is not the source of direct treatment (heating) of the coating material, but it supplies an energy that activates and stabilises the combustion of the fuel and combustion agent mixture.

In addition, an additional energy input to the combustion takes place, an energy input which is reflected in an increase in the temperature which may be obtained in the combustion chamber for a given fuel mixture. This increase in the temperature may even be in the region of 500° C. above the temperature generated from the actual process of combustion of the fuel+combustion agent mixture.

With this procedure, flows may be generated that assure an excellent quality of the coatings produced, but using for this purpose lower power outputs, so that gas consumption is lower; what is more, the overheating problems stemming from using high power outputs are avoided.

In addition, the procedure enables us to use all types of coating powders, from those with a high melting point (ceramic powders) to low melting-point materials, such as for example metals that are deposited at this time using cold spraying devices, i.e. the invention provides a continuous combustion procedure that extends its field of use from the field of cold spraying procedures (which operate with low temperature and high velocity) and, on the other hand, to the field of procedures using plasma (high temperature and low velocity), but reducing the limitations and problems common to HVOF procedures.

In other words, the higher temperature obtainable in combustion permits the use of less energetic mixtures of gases than those used currently in the continuous combustion processes for a given coating material. This means that gases that are less complicated in their handling and operation may be used. For example, it is possible to use methane for many applications that usually require for example propylene.

A higher coating powder melting temperature may be obtained, which enables high melting-point coating powders to be used (for example, ceramic powders) which current HVOF have difficulty in melting.

The invention also permits working at low temperatures, for instance for coating with low-melting point materials, as the presence of partially ionized gas allows combustion to be maintained, preventing it from being extinguished, for mixtures of fuel and combustion agent that do not provide stable combustion processes in conventional HVOF systems.

Another advantage of the procedure of the invention is that the electric generator used for producing the partially ionized gas may be of different power outputs according to needs. For instance, a low power generator may be used (for example, below 10 kW) which, besides a low cost, does not require large units in terms of their dimensions, as opposed to plasma units (high power above 100 kW) usually used for thermal spraying. Of course, a high-power plasma unit may be used if conditions so require, or else because such equipment is available.

In this way, the actual device can be set up easily to execute both coatings with low melting point materials and coatings with high melting point materials, besides all materials with a “medium” melting point (basically those normally used in traditional HVOF processes).

In addition, the procedure of the invention may comprise the step of injecting an additive gas in the combustion chamber (for example, compressed air) between the area of generation of the partially ionized gas and the area of injection of the combustion gases; this additive gas is mixed with the partially ionized gas before entering the combustion chamber (at this stage, the additive gas may be partially ionized by the partially ionized gas). This additive gas represents a volume of hot gas that is fed into the combustion chamber. This supply of additive gas to the combustion chamber permits reduction of the volumes of combustion gases (fuel and oxygen, for example) needed, thereby maintaining pressure in the chamber and, therefore, a high spraying velocity, but reducing the energy output of combustion and, therefore, the usual problems of overheating in second generation HVOF procedures.

The delivery flow of additive gas may be large in comparison with the flow of partially ionized gas. It may be preferable for the flow of additive gas to be at least twice the flow of partially ionized gas (considering equivalent flows at atmospheric pressure). For example, in a typical case, an additive gas may be supplied with a flow in the region of 100 litres (or “standard litres”) per minute, to a partially ionized gas with a flow in the region of 20 litres (or “standard litres”) per minute.

The partially ionized gas may be generated by means of the step of generating at least one electric arc and directing a plasmagenic gas through the aforesaid at least one electric arc in order to obtain said partially ionized gas. Being generated electrically, the partially ionized gas permits an adjustment or regulation of the power applied to the procedure in a very simple fashion: we merely have to adjust the current and voltage of the partially ionized gas generator in order to obtain different power outputs. In this way, when it is introduced into the combustion chamber, a system is available in which its temperature may be raised gradually at will by merely actuating on a kind of “potentiometer”. In other words, we may regulate the at least one electric arc in order to adjust the energy input (temperature and/or chemical activity) to the fuel mixture in the combustion chamber.

The fuel may be, for example, a combustible hydrocarbon, such as for instance methane, propane, propylene, butane or mixtures of these.

The combustion agent may be, for instance, oxygen or air.

The partially ionized gas (or the plasmagenic gas from which the partially ionized gas is produced) may be, for instance, argon, helium, neon, hydrogen, or a mixture of these.

When an electric arc is used, that arc may be generated with a power below, for instance, 10 kW.

Another aspect of the invention refers to a thermal spraying device for executing coatings of pieces and/or substrates, which comprises:

at least one combustion chamber, provided with at least one fuel input, at least one combustion agent input and at least one outlet for the issue of combustion gases, in the form of a flow of hot gas, from said combustion chamber towards a piece and/or substrate; and

at least one input for the injection of a coating material, so that said coating material is mixed with the flow of hot gas, downstream in relation to the combustion chamber.

In accordance with the invention, the device further comprises:

a part for generation of partially ionized gas, which comprises an electric arc generator and a system for directing plasmagenic gas from a plasmagenic gas input to a partially ionized gas output via the electric arc generator, said electric arc generator being configured to generate an electrical discharge in the plasmagenic gas by means of at least one electric arc, so that the partially ionized gas is produced, said partially ionized gas output being in communication with the combustion chamber for the injection of the partially ionized gas into said combustion chamber.

What has been stated above in relation to the method is also applicable to the device, mutatis mutandis.

The device may comprise an additive gas input for the injection of additive gas (for example, air) into the combustion chamber. Said additive gas input may communicate with said partially ionized gas output, so that the additive gas injected via said additive gas input is mixed with the partially ionized gas before reaching the combustion chamber, where it is mixed with the combustion gases.

The device may comprise at least one regulating element (for example, of the potentiometer type) functionally associated with the electric arc generator in order to permit the regulation of the at least one electric arc, so as to adjust the energy input to the fuel mixture in the combustion chamber.

The outlet for the output of combustion gases may communicate with a conduit for the flow of hot gas. Said conduit for the flow of hot gas may be formed of a conduit in the barrel of a spray gun.

The input for the injection of a coating material in powder form may communicate with said conduit for the flow of hot gas.

The electric arc may be configured in order to generate said at least one electric arc with an output below 10 kW.

The device may be configured to maintain an input of the partially ionized gas into the combustion chamber during substantially the whole duration of a combustion process in the combustion chamber.

### DESCRIPTION OF THE FIGURES

To supplement the description that is being given and in order to assist in a clearer understanding of the features of the invention, in accordance with a preferred practical embodiment of same, a set of drawings is adjoined as an integral part of said description, wherein there is represented on an informative and non-restrictive basis the following:

FIG. 1.—It shows a diagrammatic view of a procedure according to a preferred embodiment of the invention.

FIG. 2.—It shows a conceptual diagrammatic longitudinal sectional view of a device according to a preferred embodiment of the invention.

FIG. 3.—It shows a photograph of a microstructure of a tungsten carbide coating obtained with the procedure of the invention.

### PREFERRED EMBODIMENT OF THE INVENTION

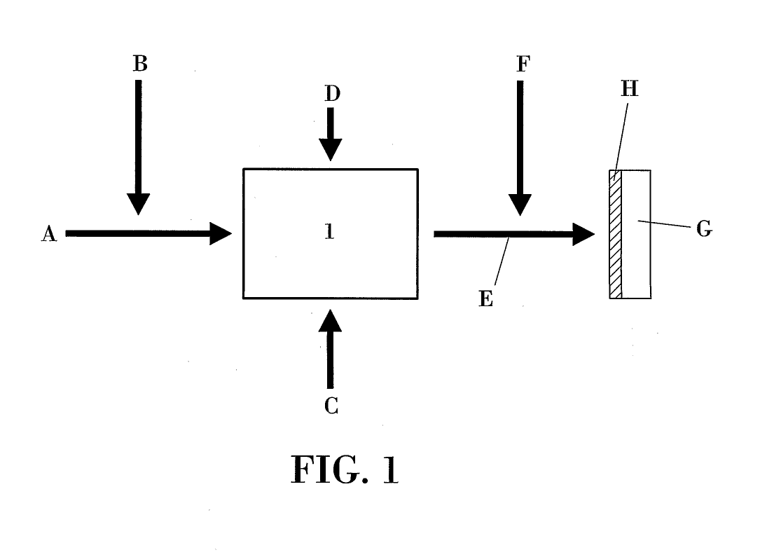

FIG. 1 illustrates diagrammatically a process according to a preferred embodiment of the invention, in which a partially ionized gas A is generated, to which is added an additive gas B (for example, air), which mixes with the partially ionized gas. This mixture is introduced into a combustion chamber 1, in which fuel C and combustion agent D are added. The combustion which takes place in the combustion chamber 1 generates a flow of hot gas E. Furthermore, a coating material F is introduced into said stream or flow E, so that it is mixed with the stream, which is directed at the surface or substrate G to be coated, in a conventional way.

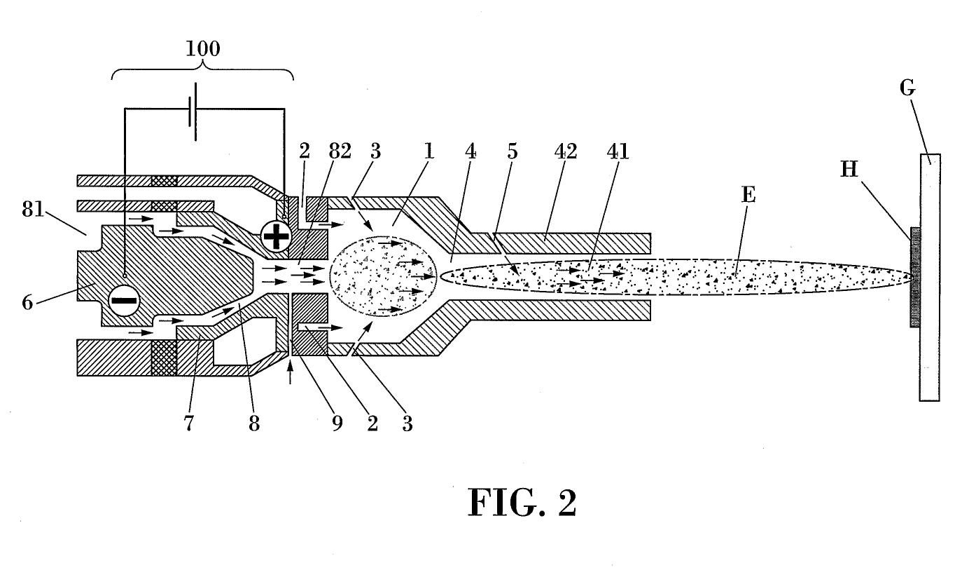

FIG. 2 illustrates diagrammatically a device according to a preferred embodiment of the invention. The device comprises a combustion chamber 1, provided with a fuel inlet 2, with a combustion agent inlet 3 and an outlet 4 for the output of combustion gases, in the form of a flow of hot gas E from said combustion chamber towards a piece and/or substrate G, on which the coating H will be deposited.

Furthermore, the device comprises an inlet 5 for the injection of a coating material, so that the coating material is mixed with the flow of hot gas, downstream in relation to the combustion chamber 1.

The device also comprises a part 100 for generation of partially ionized gas which comprises a system for directing 8 plasmagenic gas from a plasmagenic gas inlet 81 to a partially ionized gas outlet 82, via an electric arc generator configured to generate a discharge in the form of an electric arc in the plasmagenic gas, so as to generate thereby the partially ionized gas from said plasmagenic gas. The partially ionized gas outlet 82 is in communication with the combustion chamber 1 for the injection of the partially ionized gas into said combustion chamber 1.

In addition, there is an additive gas (for example, air) inlet 9 for the injection of an additive gas into the combustion chamber 1. This additive gas inlet 9 communicates with the partially ionized gas outlet 82, so that an additive gas introduced via said additive gas inlet 9 is mixed with the partially ionized gas, before reaching the combustion chamber 1 to be mixed with the combustion gases.

The electric arc generator comprises an anode 7 and a cathode 6 connected to the corresponding power supply, and it is configured to generate the partially ionized gas with at least one electric arc. In addition, the electric arc generator is functionally associated with a regulating element (of the potentiometer type) to permit the regulation of the at least one electric arc, so as to adjust the energy input to the combustion process in the combustion chamber (1).

The outlet 4 for the output of combustion gases communicates with a conduit 41 for the flow of hot gas, formed of a conduit in the barrel 42 of a spray gun. The inlet 5 for the injection of a coating material in powder form communicates with the conduit 41 for the flow of hot gas, whose expansion via an outlet hole 43 in the conduit 41 causes the acceleration of hot gas up to supersonic speeds.

The average expert on the subject will easily be able to adapt this configuration to the specific features of each case (in accordance with the features of the process, for example, the type of coating to be done, the materials and gases that are used, etc.)

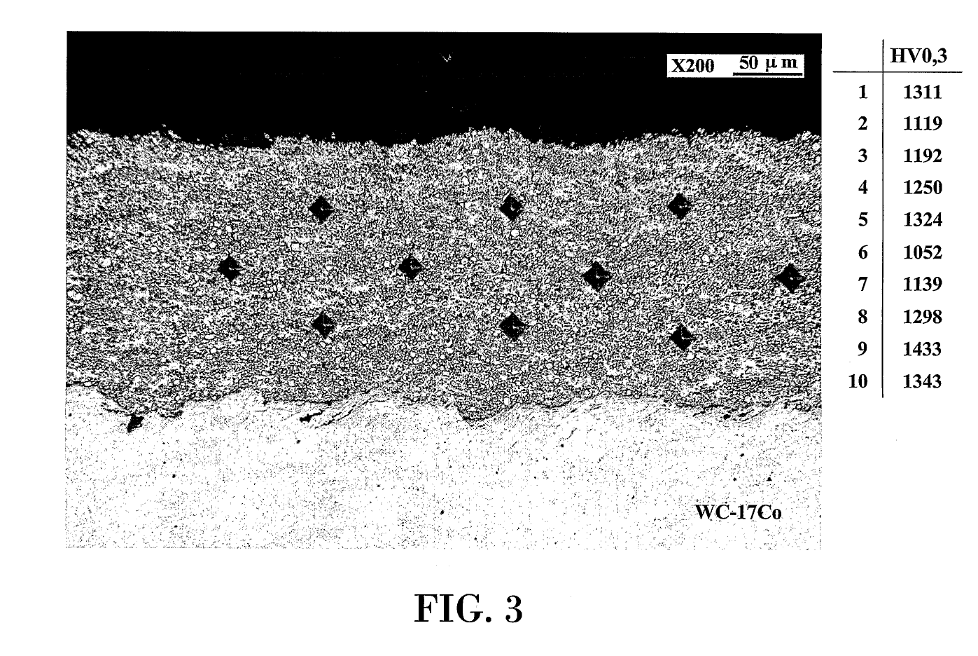

FIG. 3 is a photograph of the microstructure of a tungsten carbide coating obtained with the process of the invention. In the photograph a series of points are marked indicating the hardness obtained at each one of them in HV0.3 units. The hardnesses obtained at the different points (1311, 1119, 1192, 1250, 1324, 1052, 1139, 1298, 1433, 1343) are the standard values for a layer of tungsten, but this coating was obtained with very low gas consumption. The parameters of the process with which the coating was obtained are as follows:

Electrodes were used that formed a 400-ampere arc at 25 volts, between which 25 sl/min of argon were injected (“sl” represents “standard litres”, that is to say, the volume in pressure and temperature conditions which are considered standard).

The partially ionized gas was mixed with 100 sl/min of air.

200 sl/min of methane and 300 sl/min of oxygen were injected into the combustion chamber.

At the combustion chamber outlet a gun barrel was used with a length of 100 mm and a diameter of 8 mm.

50 gr/min of coating powder (WC-17Co) was injected into the gun barrel.

The thermal spraying was carried out on a substrate material composed of steel.

In this text, the word “comprises” and its variants (such as “comprising”, etc.) should not be interpreted in an exclusive sense, i.e. they do not exclude the possibility of what is described here including other items, steps, etc.

Furthermore, the invention is not confined to the specific embodiments that have been described, but it also encompasses, for example, the variants that may be produced by the average expert on the matter (for example, with regard to the choice of materials, dimensions, components, configuration, etc.), within the scope of what may be deduced from the claims.

1. Method of thermal spraying for the execution of coatings of pieces and/or substrates by a continuous high-velocity combustion process, which comprises:
continuously introducing at least one fuel and at least one combustion agent into a combustion chamber with at least one outlet;
generating the combustion of a mixture of said fuel and combustion agent in order to produce combustion gases in the combustion chamber, so that the combustion gases flow out of said at least one outlet, in the form of a flow of hot gas;
adding to said flow of hot gas, downstream in relation to the combustion chamber, a coating material, so that said coating material is mixed with the flow of hot gas; and
spraying the coating material, mixed with the flow of hot gas, onto at least one piece and/or substrate to be coated with the coating material;
wherein it further comprises the following steps:
generating a partially ionized gas;
introducing said partially ionized gas into the combustion chamber so that it causes the combustion of said fuel and combustive agent.

2. Method according to claim 1, wherein it further comprises the step of injecting an additive gas into the combustion chamber.

3. Method according to claim 2, wherein said additive gas is injected in such a way that the additive gas is mixed first with the partially ionized gas and is then injected into the combustion chamber for mixing with the combustion gases.

4. Method according to claim 1, wherein the partially ionized gas is generated by means of the step of generating at least one electric arc and directing a plasmagenic gas through said at least one electric arc in order to obtain said partially ionized gas.

5. Method according to claim 4, wherein it comprises the step of regulating the at least one electric arc in order to adjust the energy input to the combustion process in the combustion chamber.

6. Method according to claim 4, wherein said at least one electric arc is generated with a power output of less than 10 kW.

7. Method according to claim 1, wherein the partially ionized gas is introduced into the combustion chamber during substantially the whole duration of the combustion of the fuel and combustion agent mixture.

8. Thermal spraying device for executing coatings of pieces and/or substrates, which comprises:
at least one combustion chamber, provided with at least one fuel inlet, at least one combustion agent inlet and at least one outlet for the output of combustion gases, in the form of a flow of hot gas, from said combustion chamber towards a piece and/or substrate;
at least one inlet for the injection of a coating material, so that said coating material is mixed with the flow of hot gas, downstream in relation to the combustion chamber;
wherein it further comprises:
a part for generation of partially ionized gas, which comprises an electric arc generator and a system for directing plasmagenic gas from a plasmagenic gas inlet to a partially ionized gas outlet through the electric arc generator, the electric arc generator being configured to generate an electric discharge in the plasmagenic gas by means of at least one electric arc, so that the partially ionized gas is produced, said partially ionized gas outlet being in communication with the combustion chamber for the injection of the partially ionized gas into said combustion chamber.

9. Device according to claim 8, wherein it further comprises an additive gas inlet for the injection of an additive gas into the combustion chamber.

10. Device according to claim 9, wherein said additive gas inlet communicates with said partially ionized gas outlet, so that an additive gas introduced via said additive gas inlet mixes with the partially ionized gas, before reaching the combustion chamber to be mixed with the combustion gases.

11. Device according to claim 8, wherein it comprises at least one regulating element functionally associated with the electric arc generator in order to permit the regulation of the at least one electric arc for the purpose of adjusting the energy input to the combustion process in the combustion chamber.

12. Device according to claim 8, wherein the outlet for the output of combustion gases communicates with a conduit for the flow of hot gas.

13. Device according to claim 12, wherein said conduit for the flow of hot gas is formed of a conduit in a barrel of a spray gun.

14. Device according to claim 12, wherein the inlet for the injection of a coating material in powder form communicates with said conduit for the flow of hot gas.

15. Device according to claim 8, wherein said electric arc generator is configured to generate said at least one electric arc with a power output of less than 10 kW.

16. Device according to claim 8, wherein it is configured to maintain an introduction of the partially ionized gas into the combustion chamber during substantially the whole duration of a combustion process in the combustion chamber.

17. Device according to claim 8, said device being arranged for executing said coatings of pieces and/or substrates by a continuous high-velocity combustion process.
